(19) United States
(12) Patent Application Publication
(10) Pub. No.: US 2003/0151686 A1
(43) Pub. Date: Aug. 14, 2003

(54) Solid-state image pickup device, defective pixel conversion method, defect correction method, and electronic information apparatus

(75) Inventor: Eiji Koyama, Soraku-gun (JP)

Correspondence Address: EDWARDS & ANGELL, LLP, P.O. Box 9169, Boston, MA, 02209, US

(73) Assignee: Sharp Kabushiki Kaisha

(21) Appl. No.: 10/358,124

(22) Filed: Feb. 4, 2003

(30) Foreign Application Priority Data
Feb. 13, 2002 (JP) 2002-035940

(51) Int. Cl. H04N 3/14

(52) U.S. Cl. 348/304

(57) ABSTRACT

A solid-state image pickup device is provided which comprises a plurality of pixels arranged two-dimensionally. Each pixel comprises a reset section for resetting an electric charge accumulation voltage generated by photoelectric conversion, and an amplification section for outputting a signal voltage corresponding to the electronic charge accumulation voltage, a voltage switch section for switching a voltage to be supplied to the reset section between a reset voltage and a second reference voltage, the second reference voltage being lower than the reset voltage; and a voltage fix section for fixing the electronic charge accumulation voltage to a predetermined value.

### BACKGROUND OF THE INVENTION

1. Field of the Invention

The present invention relates to a solid-state image pickup device for use in various cameras, such as, for example, video cameras, surveillance cameras, front-door intercom cameras, in-vehicle cameras, cameras for videophones, cameras for mobile telephones, and the like, camera systems using these cameras, or the like. The present invention also relates to a defective pixel conversion method for the solid-state image pickup device, and a defect correction method using this defective pixel conversion method. The present invention also relates to an electronic information apparatus comprising this solid-state image pickup device.

2. Description of the Related Art

At present, CMOS-type solid-state image pickup devices generally used are provided with a diffusion layer having a floating potential, which is called a floating diode, on a semiconductor substrate. The diffusion layer converts incident light to electricity. Electric charges generated by this photoelectric conversion are converted to a voltage by the capacitance component of the PN junction of the diffusion layer. A signal component is then output depending on the voltage of the electric charge. Thereafter, by applying a reset pulse (reset control signal) to the gate of a reset transistor, unnecessary electric charges accumulated in the floating diode portion is removed through the reset drain portion so as to reset the potential of electric charges accumulated in the floating diode portion to a predetermined reset voltage.

FIG. 5 is a circuit diagram showing a major configuration of a conventional CMOS-type solid-state image pickup device.

Referring to FIG. 5, the CMOS-type solid-state image pickup device is provided with a plurality of pixels 20 which are arranged in a two-dimensional matrix having rows and columns on a semiconductor substrate 21. Each pixel has an (x, y)-address indicated by (i, j). The pixel 20 comprises a select switch transistor 1, a reset transistor 2, a floating diode 3, and an amplification transistor 4. Note that i and j are natural numbers.

The select switch transistor 1 has a source which is connected to a column signal line 5, a drain which is connected to the source of the amplification transistor 4, and a gate which is connected to a select pulse signal line 6. The image pickup device is provided with a plurality of select pulse signal lines 6 which are arranged in parallel to each other. A select pulse signal line 6 is provided for each row. The select pulse signal line 6 is supplied with a select pulse from a vertical select switch decoder 8. When the select pulse is applied to the gate of the select switch transistor 1, a plurality of pixels 20 on a row of the two-dimensional matrix are selected to output a signal component to the column signal line 5.

The reset transistor 2 has a source which is connected to an electric charge accumulation region N1, a drain which is connected to the application portion of a voltage reset drain VRD, and a gate which is connected to a reset pulse signal line 7. The reset pulse signal line 7 is connected to the gates of the reset transistors 2 of a plurality of pixels 20 on a row of the two-dimensional matrix. A reset pulse is selectively supplied through a vertical reset decoder 9 to the reset pulse signal line 7. When the reset pulse is applied to the gate of the reset transistor 2, conduction (short circuit) occurs between the electric charge accumulation region N1 and the drain of the reset transistor 2, so that electric charges accumulated in the electric charge accumulation region N1 are discharged to the drain of the reset transistor 2.

The floating diode 3 comprises a PN junction. Electric charges generated by photoelectrically converting incident light are accumulated in the electric charge accumulation region N1 having a floating potential.

The amplification transistor 4 has a source which is connected to the drain of the select switch transistor 1, a drain which is connected to a power source voltage (VDD) terminal, and a gate which is connected to the electric charge accumulation region N1. The amplification transistor 4 outputs a signal voltage amplified depending on an electric charge accumulation voltage corresponding to the amount of incident light which has been photoelectrically converted by the floating diode 3.

The column signal line 5 is provided in parallel to each column of a plurality of pixels 20. One end of the column signal line 5 is connected to the drain of a corresponding vertical select transistor 10, while the other end is connected through a constant current source 14. The gate of the horizontal select transistor 10 is connected to a horizontal select switch decoder 11. A column select pulse is input from the horizontal select switch decoder 11 to the gate of the horizontal select transistor 10 so as to sequentially select each column signal line 5. By selecting the column signal line 5, a plurality of pixels 20 on the corresponding column are selected from the two-dimensional matrix of pixels 20. A signal component is output from the pixel 20 on the selected row and column through the horizontal select transistor 10 to an output horizontal signal line 12, and then is output through an output circuit 13 as a signal voltage.

FIG. 6 is a timing chart for explaining an operation of the CMOS-type solid-state image pickup device of FIG. 5.

Referring to FIG. 6, when a reset pulse goes to a high level at the beginning of one frame period so that a positive voltage is applied to the gate of a reset transistor 2 on a j^{th} row, conduction (short circuit) occurs between the application portion of the voltage reset drain (VRD) and the electric charge accumulation region N1 in terms of potential, and as a result, the potential of the electric charge accumulation region N1 is fixed to the potential of the voltage reset drain (VRD).

Next, when the reset pulse goes to a low level, the electric charge accumulation region lispotentially shut off from the voltage reset drain (VRD), and as a result, the voltage of the floating diode 3 is lowered by the field-through component (Δ) of the reset pulse and is temporarily fixed. This field-through component (Δ) is generally about 100 mV to about 400 mV. If light enters the floating diode 3 during the shut-off between the application portion of the voltage reset drain (VRD) and the floating diode 3, electric charges are generated in proportion to the amount of the incident light and the electric charges are converted to a negative voltage. As a result, the potential of the electric charge accumulation region N1 which has been reset to the voltage reset drain is gradually lowered.

After the reset operation is ended in this manner and a predetermined time (one frame period) has passed, a select pulse goes to the high level so that the pixels 20 on the j^{th} row are selected by respective select switch transistors 1. As a result, a signal component depending on the voltage value SIG of electric charge generated by photoelectrically converting incident light is output to a corresponding column signal line 5.

When the pixels 20 on the j^{th} row are selected, column select pulses are sequentially output from the horizontal select switch decoder 11 so as to sequentially select the horizontal select transistor 10 (horizontal select switch) on the i^{th} column, which is then turned ON so that a signal component is output from the pixel 20 at address (i, j) to the output horizontal signal line 12 in a time-series manner.

In this case, if the reset pulse on the j^{th} row goes to the high level again immediately after the horizontal select transistor 10 on the i^{th} row is tuned from the ON state to the OFF state, a positive voltage is applied to the gate voltage of the reset transistor 2 on the j^{th} row, and as a result, the potential of the electric charge accumulation region N1 is reset to the potential of the voltage reset drain again. Such an operation is carried out for each frame period (e.g., 30 ms).

In general, the high level of the above-described reset pulse and select pulse is the power source voltage, and the low level thereof is 0 V, where the power source voltage is assumed to be 3 V.

Next, a method for testing the pixel 20 of the above-described solid-state image pickup device will be described.

The yield of the solid-state image pickup device varies depending on the presence or absence of an operation defective pixel. Operation defects in the pixel 20 are roughly grouped into a white defect in a dark background and a black defect in a bright background. As used herein, “white defect in a dark background” indicates that a signal component is generated from the pixel 20 when blocking light i.e., no image light enters a photodiode (the floating diode 3). As used herein, “black defect in a bright background” indicates that the pixel 20 does not respond to image light and no signal component or an imperfect signal component is generated when picking up an image, i.e., the image light enters a photodiode.

A major cause for a white defect in a dark background is believed to be a defect within a pixel. A cause for a black defect in a bright background is believed to be attachment of a dust to a surface of a solid-state image pickup device, abnormality in the shape of a metal wiring, deformation of a microlens provided for condensing image light onto a photodiode, or the like. Note that the black defect in a bright background is a phenomenon that is generated since image light is prevented from entering a photodiode due to some cause, and therefore, such a defect is not confirmed when blocking light.

The presence or absence of a white defect in a dark background is determined as follows. Signal outputs from all pixels 20 are measured where a photodiode is shielded from image light. If the number of pixels 20 having an output greater than or equal to a predetermined level is greater than or equal to a predetermined number, the solid-state image pickup device is determined to have a white defect in a dark background. On the other hand, the presence or absence of a black defect in a bright background is determined as follows. Signal outputs from all pixels 20 are measured where uniform light enters their photodiodes. If the number of pixels 20 having an output smaller than or equal to a predetermined level is greater than or equal to a predetermined number, the solid-state image pickup device is determined to have a black defect in a bright background. Therefore, the black defect in a bright background cannot be tested when blocking light.

The above-described white defect in a dark background or black defect in a bright background occurs in a predetermined number per unit area. Therefore, the more the number of pixels per unit area, the greater the possibility that an operation defective pixel 20 occurs in a solid-state image pickup device due to a white defect in a dark background, a black defect in a bright background, or the like, i.e., the more the reduction in the yield of a solid-state image pickup device. Therefore, the reduction of a white defect in a dark background or a black defect in a bright background can contribute much to an increase in yield and a decrease in cost.

Japanese Laid-Open Publication No. 10-322603 discloses an electronic camera in which a defect is corrected when assembling the electronic camera in order to reduce the number of defective pixels 20, for example.

This defect correction is carried out as follows. An image pickup test is performed under predetermined conditions. When a certain pixel has a signal output having a level greater than or equal to a predetermined level or smaller than or equal to a predetermined level, the address of the pixel is stored into a non-volatile memory provided in a camera system. The output of the pixel whose address is stored in the non-volatile memory is replaced with the output of a pixel at an address adjacent to the stored address.

According to this defect correction, the addresses of defective pixels can be stored to an extent that corresponds to the capacity of the non-volatile memory. Therefore, a solid-state image pickup device is determined to be defective only if the solid-state image pickup device contains more defective pixels than the capacity of the non-volatile memory. The yield of solid-state image pickup devices can be significantly improved.

However, the above-described defect correction which is performed when assembling a camera system is constrained as follows. Whereas a white defect in a dark background can be corrected by detecting a white defect when shielding a photodiode from light, correction of a black defect in a bright background requires a predetermined amount of light entering a photodiode. It is a complicated task to provide a particular light source for supplying a predetermined amount of light to a photodiode when assembling a camera system, thereby making an assembly process more complicated and manufacturing cost higher. In general, therefore, when assembling a camera system, defect correction is not performed for a black defect in a bright background which requires a particular light source, and defect correction is performed only for a white defect in a dark background which requires no light source. Therefore, since defect correction is not performed for a black defect in a bright background when assembling a camera system, there remains a large problem that the yield of solid-state image pickup devices is reduced. The manufacturing cost of solid-state image pickup devices is thus still high.

In order to perform the above-described defect correction for a black defect in a bright background, it is preferable that each solid-state image pickup device is provided with a non-volatile memory for storing the addresses of defective pixels. However, a particular manufacturing process (e.g., a process of incorporating a flash memory, etc.) is required for incorporating a non-volatile memory into the same chip, resulting in an increase in the manufacturing cost of solid-state image pickup devices. To avoid this, a non-volatile memory provided in a camera system may be used. In this case, defect correction for a black defect in a bright background is required when assembling a camera system.

### SUMMARY OF THE INVENTION

According to one aspect of the present invention, a solid-state image pickup device comprises: a plurality of pixels arranged two-dimensionally, wherein each pixel comprising a reset section for resetting an electric charge accumulation voltage generated by photoelectric conversion, and an amplification section for outputting a signal voltage corresponding to the electronic charge accumulation voltage; a voltage switch section for switching a voltage to be supplied to the reset section between a reset voltage and a second reference voltage, the second reference voltage being lower than the reset voltage; and a voltage fix section for fixing the electronic charge accumulation voltage to a predetermined value.

In one embodiment of this invention, the reset section is a reset transistor comprising a first drive terminal, a second drive terminal, and a control terminal, wherein an electric charge accumulation voltage generated by photoelectric conversion is applied to the first drive terminal, a reset control voltage is applied to the control terminal, and a reset voltage is applied to the second drive terminal, so that the electric charge accumulation voltage is reset; and the amplification section is an amplification transistor comprising a first drive terminal, a second drive terminal, and a control terminal, wherein the electronic charge accumulation voltage is applied to the control terminal and a first reference voltage is applied to the first drive terminal, so that a signal voltage corresponding to the electronic charge accumulation voltage is output from the second drive terminal, the voltage switch section is a voltage switch section for switching a voltage supplied to the second terminal of the reset transistor between the reset voltage and the second reference voltage, the second reference voltage being lower than the reset voltage, and the voltage fix section is a short circuit path which short circuits between the second terminal and the control terminal of the amplification transistor.

According to another aspect of the present invention, a solid-state image pickup device comprises a plurality of pixels arranged two-dimensionally. Each pixel comprises: a reset transistor comprising a first drive terminal, a second drive terminal, and a control terminal, wherein an electric charge accumulation voltage generated by photoelectric conversion is applied to the first drive terminal, a reset control voltage is applied to the control terminal, and a reset voltage is applied to the second drive terminal, so that the electric charge accumulation voltage is reset; and an amplification transistor comprising a first drive terminal, a second drive terminal, and a control terminal, wherein the electronic charge accumulation voltage is applied to the control terminal and a first reference voltage is applied to the first drive terminal, so that a signal voltage corresponding to the electronic charge accumulation voltage is output from the second two drive terminals, and a voltage switch section for switching a voltage supplied to the second terminal of the reset transistor between the reset voltage and a second reference voltage, the second reference voltage being lower than the reset voltage, so that a voltage greater than or equal to the voltage rating of a transistor can be applied the first drive terminal of the amplification transistor to cause a short circuit between the second drive terminal and the control terminal of the amplification transistor.

In one embodiment of this invention, the plurality of pixels are arranged in a matrix having rows and columns, and the voltage switch section switches a voltage supplied to the second drive terminal of the reset transistor between the reset voltage and a predetermined voltage or a ground voltage on a column-by-column basis, wherein the predetermined voltage is lower than the reset voltage, and the ground voltage is the second reference voltage.

In one embodiment of this invention, the voltage switch section is an inverter.

According to another aspect of the present invention, a defective pixel conversion method comprises the steps of: applying light to the pixels of the above-described solid-state image pickup device on a wafer; detecting a defective pixel with no response or an imperfect response to the light from the pixels; and short circuiting the defective pixel between the first drive terminal and the control terminal of the amplification transistor thereof.

In one embodiment of this invention, the second reference voltage is applied to the second drive terminal of the reset transistor of the defective pixel while the reset control voltage is applied to the control terminal of the reset transistor of the defective pixel, and a voltage greater than or equal to the voltage rating is applied to the first drive terminal of the amplification transistor.

According to another aspect of the present invention, a solid-state image pickup device comprises a pixel, wherein the pixel is short circuited between the first drive terminal and the control terminal of the amplification transistor using the above-described defective pixel conversion.

According to another aspect of the present invention, a method for correcting a defect in a solid-state image pickup device, comprises the step of: replacing an output of the converted cell in the above-described solid-state image pickup device with an output of a pixel having an address adjacent of an address of the converted cell by storing the address of the converted pixel in a memory.

According to another aspect of the present invention, an electronic information apparatus, comprises: the above-described solid-state image pickup device, wherein the electronic information apparatus is used to subject image data picked up by the solid-state image pickup device to information processing.

In one embodiment of this invention, when a pixel in the solid-state image pickup device, whose electric charge accumulation region is constantly fixed to a predetermined potential, is detected, the address of the pixel is stored in a memory and an output of said pixel at the address stored in the memory is replaced with an output of a pixel having an address adjacent to the address of said pixel.

Hereinafter, functions of the present invention will be described.

According to the present invention, the connection of the drive terminal (drain) of a reset transistor contained in a pixel is switched between a reset voltage and a second reference voltage (ground voltage). Moreover, a voltage higher than or equal to the voltage rating of a transistor can be applied to the drive terminal (drain) of an amplification transistor.

When manufacturing solid-state image pickup devices, the solid-state image pickup devices on a wafer are subjected to a test. When a defective pixel having no response or an imperfect response to incident light (a so-called black defect in a bright background) is detected, a reset control voltage (a high level of reset pulse) is applied to the control terminal (gate) of a reset transistor in the defective pixel and the drain of the reset transistor is connected to the second reference voltage (ground voltage) so that the gate voltage of an amplification transistor in the pixel is set to be a low level. In this situation, by applying a voltage higher than or equal to the voltage rating of a transistor to the drive terminal (drain) of the amplification transistor, a short circuit is caused between the other drive terminal (drain) and the control terminal (gate) of the amplification transistor. Thereby, in the defective pixel having a black defect in a bright background, the electric charge accumulation region N1 is connected to one drive terminal (drain; for example, a power source voltage terminal) of the amplification transistor. Therefore, the defective pixel having a black defect in a bright background is converted into a pixel in which the electric charge accumulation region N1 is constantly fixed to a predetermined potential (=the power source potential) irrespective of the presence or absence of incident light.

Conventionally, a black defect in a bright background cannot be detected when shielding a photodiode from light. According to the present invention, a defective pixel having a black defect in a bright background has an electric charge accumulation region which is constantly fixed to the power source potential. Therefore, such a defective pixel can output a negative signal corresponding to the field-through of a reset pulse, which is not output from a normal pixel, even when blocking light, thereby making it possible to detect this defective pixel. Therefore, in a manufacturing process for a product, such as a camera, a pixel having a black defect in a bright background, whose electric charge accumulation region is constantly fixed to a predetermined potential, can be easily detected along with a white defect in a dark background without a particular light source. That is, a black defect in a bright background and a white defect in a dark background are simultaneously subjected to defect correction.

The reset voltage which is applied to the drain of the reset transistor may be the power source voltage. Alternatively, when the reset voltage is lower than the power source voltage supplied from the voltage generation circuit, it is possible to output a negative signal corresponding to the field-through of a reset pulse plus the difference between the reset voltage (e.g., the power source voltage) and a second reference voltage (a voltage lower than the power source voltage). Therefore, a pixel whose electric charge accumulation region is constantly fixed to a predetermined potential can be more easily detected.

Thus, the invention described herein makes possible the advantages of providing: a solid-state image pickup device in which defect correction for a black defect in a bright background can be easily performed; a defective pixel conversion method for the solid-state image pickup device; a defect correction method using the defective pixel conversion method; and an electronic information apparatus comprising this solid-state image pickup device.

These and other advantages of the present invention will become apparent to those skilled in the art upon reading and understanding the following detailed description with reference to the accompanying figures.

### BRIEF DESCRIPTION OF THE DRAWINGS

FIG. 1 is a circuit diagram showing a CMOS-type solid-state image pickup device according to Embodiment 1 of the present invention.

FIG. 2 is a timing chart for explaining an operation of the CMOS-type solid-state image pickup device of FIG. 1.

FIG. 3 is a circuit diagram showing a CMOS-type solid-state image pickup device according to Embodiment 2 of the present invention.

FIG. 4 is a timing chart for explaining an operation of the CMOS-type solid-state image pickup device of FIG. 3.

FIG. 5 is a circuit diagram showing a conventional CMOS-type solid-state image pickup device.

FIG. 6 is a timing chart for explaining an operation of the CMOS-type solid-state image pickup device of FIG. 5.

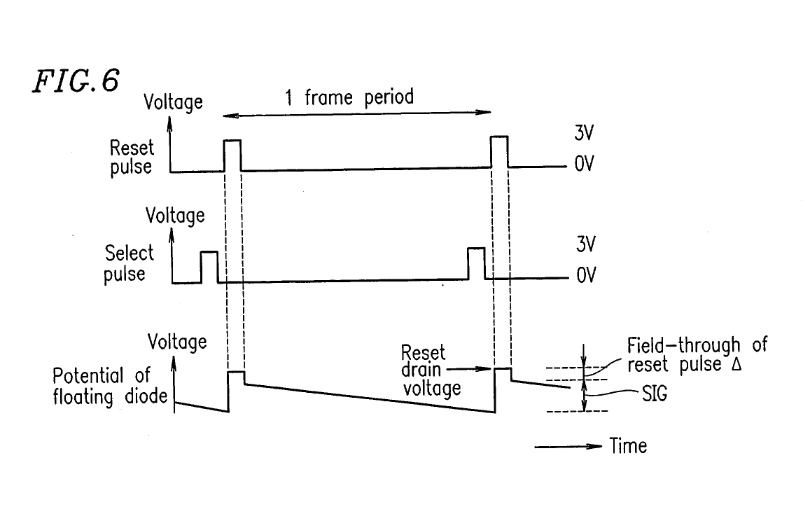

FIG. 7 is a block diagram showing a basic structure of an electronic information apparatus comprising the solid-state image pickup device of the present invention.

### DESCRIPTION OF THE PREFERRED EMBODIMENTS

Hereinafter, the present invention will be described by way of illustrative examples with reference to the accompanying drawings.

(Embodiment 1)

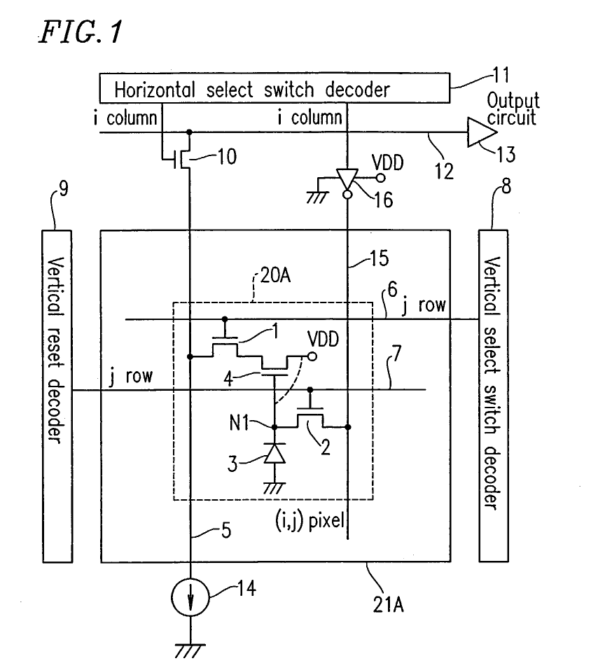

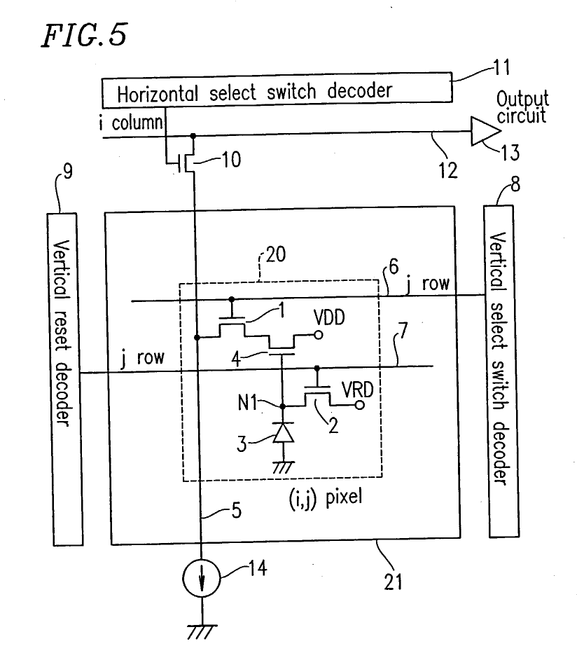

FIG. 1 is a circuit diagram showing a CMOS-type solid-state image pickup device according to Embodiment 1 of the present invention. Note that members having the same functions as those of corresponding members in FIG. 5 are indicated by the same reference numerals.

Referring to FIG. 1, the CMOS-type solid-state image pickup device is provided with a plurality of pixels 20A which are arranged in a two-dimensional matrix having rows and columns on a semiconductor substrate 21A. Each pixel has an (x, y)-address indicated by (i,j). Each pixel 20A comprises a select switch transistor 1, a reset transistor 2 (reset section), a floating diode 3, and an amplification transistor 4 (amplification section), where a voltage higher than or equal to the voltage rating of a transistor for a drain/gate short circuit can be applied to the drain terminal of the amplification transistor 4: the drain terminal of the reset transistor 2 on each column is connected to a common drain power source line 15 as a voltage switch section: and the connection of the drain terminal of the reset transistor 2 can be switched between a reference potential section and a ground (GND) potential section by a selection switch 16 (the selection switch 16 may comprise an inverter) for each column of pixels 20A.

A floating diode 3 comprises a PN junction, in which electric charges generated by photoelectrically converting light are accumulated in an electric charge accumulation region N1 having a floating potential.

The amplification transistor 4 has a drain (one driving terminal) connected to a power source voltage (VDD) terminal, a source (the other driving terminal) connected to the drain (driving terminal) of the select switch transistor 1, and a gate (control terminal) connected to the electric charge accumulation region N1. The amplification transistor 4 outputs a signal voltage amplified depending on an electric charge accumulation voltage corresponding to the amount of incident light which has been photoelectrically converted by the floating diode 3.

The select switch transistor 1 has a source connected to a column signal line 5, a drain connected to the source of the amplification transistor 4, and a gate connected to a select pulse signal line 6. A select pulse is supplied to the gate of the select switch transistor 1 from a vertical select switch decoder 8. Pixels 20A on a row are selected by applying a select pulse to the gates of the respective select switch transistors 1. The output signals of the pixels 20A are supplied to the respective column signal lines 5.

A column signal line 5 is provided for each column of pixels 20A. The column signal lines 5 are arranged in parallel to each other, each of which has one end connected to the drain of a corresponding horizontal select transistor 10 and the other end connected through a constant current source 14 to the GND potential section.

The gate of the horizontal select transistor 10 is connected to a horizontal select switch decoder 11. The column signal lines 5 are sequentially selected by inputting a select pulse from the horizontal select switch decoder 11 to the gates of the respective horizontal select transistors 10. Thereby, a signal voltage from a column signal line 5 in a selected column is output to a horizontal signal line 12 connected to the source of the horizontal select transistor 10 and is then output through an output circuit 13.

In Embodiment 1, the reset transistor 2 has a source connected to the electric charge accumulation region N1, a drain connected to a drain power source line 15, and a gate to which a reset pulse (reset control signal) is applied. The solid-state image pickup device is provided with a plurality of drain power source lines 15 arranged in parallel to each other. A plurality of reset transistors 2 on each column are connected to the corresponding common drain power source line 15. The solid-state image pickup device is provided with a plurality of reset pulse signal lines 7 arranged in parallel to each other. A plurality of pixels 20A on each row are connected to the corresponding common reset pulse signal line 7. The gate of each reset transistor 2 is connected to the corresponding reset pulse signal line 7.

The reset pulse signal line 7 is supplied with a reset pulse from a vertical reset decoder 9 so that the reset pulse is applied to the gate of a reset transistor 2. As a result, conduction (short circuit: a short circuit path is formed as a voltage fix section) occurs between the electric charge accumulation region N1 and the drain of the reset transistor 2, so that electric charges accumulated in the electric charge accumulation region N1 is removed to the drain of the reset transistor 2.

The drain power source line 15 is connected through a selection switch 16 to the horizontal select switch decoder 11. The selection switch 16 can switch between the connection of the drain power source line 15 to the power source voltage VDD and the connection of the drain power source line 15 to the GND potential according to a select signal from the horizontal select switch decoder 11. Note that in a normal drive mode, the drain power source line 15 is connected to the power source voltage VDD, and only when a defective pixel 20A is converted, the drain power source line 15 is connected to the GND potential section.

Hereinafter, a method for converting a defective pixel in the above-described solid-state image pickup device of Embodiment 1 will be described.

In Embodiment 1, when manufacturing solid-state image pickup devices, the solid-state image pickup devices on a wafer are uniformly illuminated to bring light to the respective floating diodes 3 (photodiodes). A signal output is measured for each pixel. If a pixel whose output is smaller than or equal to a predetermined level (i.e., a defective pixel which is a so-called black defect in a bright background), the detected defective pixel is converted to a pixel whose electric charge accumulation region N1 has a predetermined potential irrespective of the presence or absence of incident light.

Specifically, for example, a high level of reset pulse is applied to the gate of the reset transistor 2 on the j^{th} row. The selection switch 16 on the i^{th} column is switched to connect between the drain power source line 15 and the GND potential so that the drain of the reset transistor 2 is supplied with the GND potential. As a result, only the gate voltage of the amplification transistor 4 in the pixel 20A at address (i, j) is a low level (=0V). In this situation, a voltage higher than or equal to the voltage rating of a transistor is applied to the drain of the amplification transistor 4 from the power source terminal for a predetermined time.

As a result, a short circuit occurs between the drain and the gate of the amplification transistor 4 to form a source follower circuit as indicated by a dashed line in FIG. 1. The magnitude and duration (or repetition intervals, the number of iterations, or the like) of the applied voltage vary depending on the manufacturing process of the solid-state image pickup device. For example, if the power source voltage is 3 V, a voltage about three times more than the power source voltage (e.g., 8 V) is applied to the drain of the amplification transistor 4 for 5 seconds so that a short circuit occurs between the drain and the gate of the amplification transistor 4. Therefore, the defective pixel 20A (a black defect in a bright background) is converted into a pixel whose electric charge accumulation region N1 has a constant potential (=the power source potential) irrespective of the presence or absence of incident light.

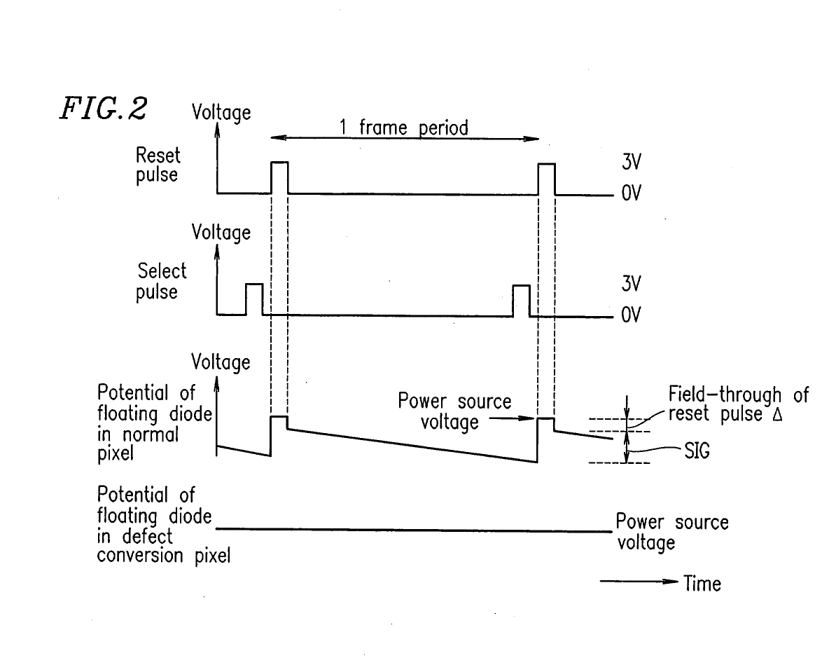

FIG. 2 is a timing chart for explaining an operation of the CMOS-type solid-state image pickup device of Embodiment 1.

Referring to FIG. 2, for a normal pixel 20A free of an operation defect, when a reset pulse goes to a high level and a positive voltage is applied to the gate of the j^{th} reset transistor 2, conduction (short circuit) occurs between the voltage reset drain (VDD) and the floating diode 3 in terms of potential. Thereby, the potential of the floating diode 3 is normally fixed to the potential of the voltage reset drain (VDD).

Next, when a reset pulse goes to a low level, the electric charge accumulation region N1 is potentially shut off from the application portion of the voltage reset drain (VDD), and as a result, the voltage of the floating diode 3 is lowered by the field-through component of the reset pulse and is temporarily fixed. If light enters the floating diode 3 when the floating diode 3 is shut off from the voltage application portion of the voltage reset drain (VDD), electric charges are generated to an extent proportional to the amount of incident light and are then converted to a negative voltage. Thereby, the potential of the reset electric charge accumulation region N1 which has been reset to the drain voltage is gradually lowered.

After the reset operation is ended in this manner and a predetermined time (one frame period) has passed, a select pulse goes to the high level so that the pixels 20A on the j^{th} row are selected by respective select switch transistors 1, and the column signal line 5 on the i^{th} column is sequentially selected. As a result, the voltage value SIG of electric charge generated by photoelectrically conversion is sequentially output as a signal component from the selected pixel 20A through the column signal line 5 on the i^{th} column and the vertical signal line 12. In other words, when the pixels 20A on the j^{th} row are selected, the horizontal select switch 10 on the i^{th} column is sequentially selected and is then turned ON so that a signal component is sequentially output from the pixel 20A at address (i, j).

In this case, if the reset pulse on the j^{th} row goes to the high level again immediately after the horizontal select transistor 10 on the i^{th} row is turned from the ON state to the OFF state, a positive voltage is applied to the gate voltage of the reset transistor 2 on the j^{th} row, and as a result, the floating diode 3 is reset to the voltage reset drain again. Such an operation is carried out for each frame period (e.g., 30 ms).

On the other hand, for a pixel 20A which is obtained by converting a defective pixel 20A (a black defect in a bright background) by short circuiting the gate and the drain of the amplification transistor 4 (a black defect in a bright background is converted into a white defect in a bright background), the electric charge accumulation region N1 is constantly fixed to a predetermined potential. Therefore, as shown in FIG. 2, a negative signal corresponding to the field-through (Δ) of a reset pulse is output irrespective of the presence or absence of incident light.

Therefore, in Embodiment 1, a pixel 20A having a black defect in a bright background which cannot be detected when blocking light is converted into a pixel 20A whose electric charge accumulation region N1 is constantly fixed to a predetermined voltage irrespective of the presence or absence of incident light. Therefore, even when blocking light, a pixel 20A having a black defect in a bright background can be detected as a defective pixel 20A having a white defect in a bright background which outputs a signal which is negative by a field-through (Δ). As a result, defect correction can be performed when manufacturing a camera system, without a particular light source. Specifically, for example, the pixel 20A whose electric charge accumulation region N1 is constantly fixed to a predetermined potential is detected and the address of this pixel 20A is stored in a non-volatile memory contained in the camera system. The output of the pixel at the address stored in the non-volatile memory is replaced with the output of a pixel having an address adjacent to that of the defective pixel.

For example, it is assumed that in a camera system, the maximum number of the addresses of defective pixels 20A which can be stored in a non-volatile memory is 10. In conventional solid-state image pickup devices, 10 or less white defects in a dark background and no black defect in a bright background can be corrected at maximum. In contrast, according to Embodiment 1, a total of 10 or less of white defects in a dark background and black defects in a bright background can be corrected. Note that a priority for defect correction may be assigned to a defective pixel 20A having a higher level of operation defect, and it is not necessary that the number of white defects in a dark background is the same as the number of black defects in a bright background.

(Embodiment 2)

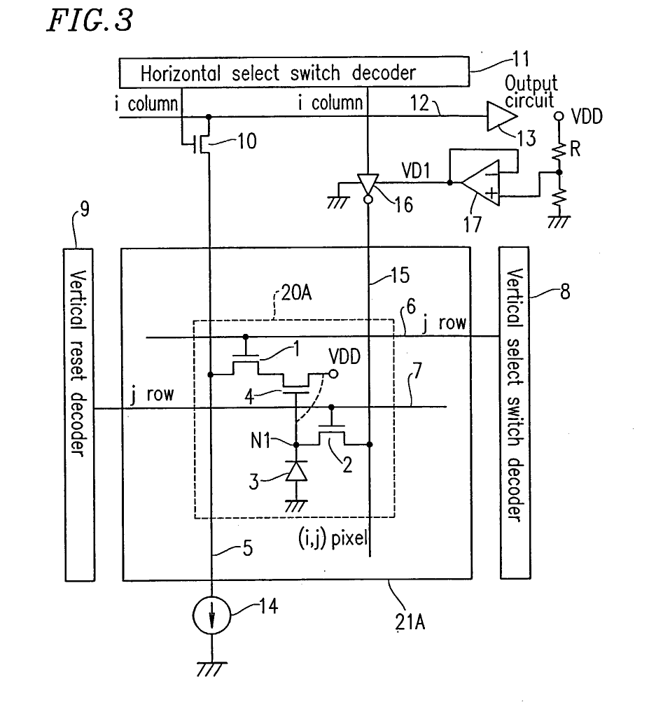

FIG. 3 is a circuit diagram showing a major configuration of a CMOS-type solid-state image pickup device according to Embodiment 2 of the present invention. Note that members having the same functions as those of corresponding members in Embodiment 1 are indicated by the same reference numerals, and a description thereof is omitted.

Referring to FIG. 3, the CMOS-type solid-state image pickup device according to Embodiment 2 is provided with a selection switch 16 which can switch between the connection of a drain power source line 15 to a voltage VD1 of a voltage generation circuit 17 and the connection of the drain power source line 15 to a GND potential, according to a select signal from a horizontal select switch decoder 11.

The voltage generation circuit 17 has a non-inverting input terminal (+) connected to a partial resistor R provided between a power source voltage VDD and a GND potential, and an output terminal connected to an inverting input terminal (−), and therefore, outputs the voltage VD1 which is lower than the power source voltage VDD.

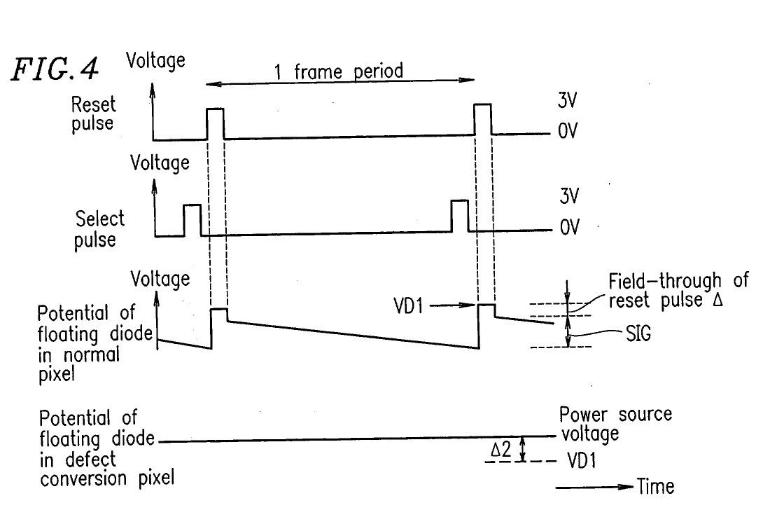

FIG. 4 is a timing chart for explaining an operation of the CMOS-type solid-state image pickup device of FIG. 3.

In the above-described solid-state image pickup device of Embodiment 1, the potential of the electric charge accumulation region N1 of the converted pixel 20A is constantly fixed to the potential of the power source voltage VDD, and therefore, a signal which is negative by the field-through (Δ) of a reset pulse is output irrespective of the presence or absence of incident light as shown in FIG. 2. However, if A is small, the converted pixel 20A may not be detected as a white defect in a dark background.

In contrast, Embodiment 2 employs the voltage VD1 which is lower than the power source voltage supplied by the voltage generation circuit 17. The voltage VD1 is used as a reference potential which is applied to the drain of the reset transistor 2 (reset section). Therefore, a signal which is negative by the field-through (Δ) plus the difference between the power source voltage VDD and the voltage VD1 (Δ2), i.e., (Δ+Δ2), is output, thereby making it easier to detect a defective pixel 20A when performing defect correction.

As described above, according to Embodiments 1 and 2, when manufacturing solid-state image pickup devices, the solid-state image pickup devices on a wafer are subjected to a test in which the wafer is illuminated with light; when a so-called black defect in a bright background which outputs no or imperfect response to the incident light is detected, this defective pixel 20A is converted into a pixel 20A whose electric charge accumulation region N1 is constantly fixed to a predetermined potential irrespective of the presence or absence of incident light. This black defect in a bright background cannot conventionally be detected with shielding a photodiode from light. However, in the present invention, the pixel having a black defect in a bright background, whose electric charge accumulation region N1 is constantly fixed to a predetermined potential, can be easily detected since a negative signal is output even when blocking light. Therefore, in a process of assembling a camera system, a pixel 20A whose electric charge accumulation region N1 is constantly fixed to a predetermined potential, can be detected in a manner similar to that of defect correction for a white defect in a dark background and without a particular light source. As a result, a manufacturing process for a solid-state image pickup device can be prevented from being complicated, and the yield at the stage of testing a wafer can be improved, thereby making it possible to reduce manufacturing cost.

As described above, according to the present invention, when testing a wafer a defective pixel having a black defect in a bright background is converted into a defective pixel having a white defect in a dark background. Therefore, black defects in a bright background can be subjected to the same defect correction as that for white defects in a dark background, whereby the yield in a wafer test can be improved while preventing the manufacturing process from being complicated. As a result, it is possible to reduce manufacturing cost.

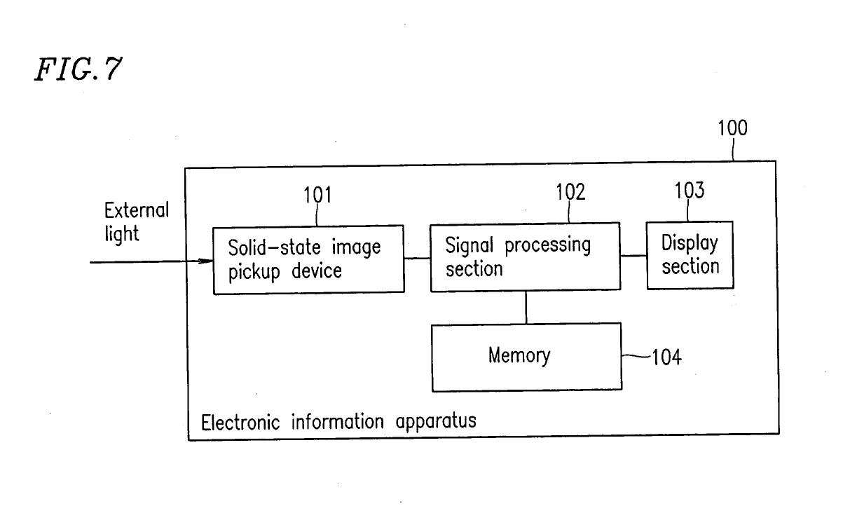

It should be appreciated that the solid-state image pickup device of the present invention can be easily incorporated into electronic information apparatuses, such as mobile telephones, cameras, and the like. In this case, the effects of the present invention can also be obtained. Referring to FIG. 7, an exemplary electronic information apparatus 100 is illustrated. This electronic information apparatus 100 comprises a solid-state image pickup device 101 according to the present invention, a signal processing section 102, a display section 103, and a memory 104. The solid-state image pickup device 101 picks up an image of an object as external light. Pixel data of the picked-up image is transferred as image data to the signal processing section 102 which performs various signal processes for the image data. The processed image data is output on the display section 103. The signal processing section 102 stores the processed image data in the memory 104, and reads the image data from the memory 104 as required and outputs the data to the display section 103. In the signal processing section 102, when a pixel in the solid-state image pickup device, whose electric charge accumulation region is constantly fixed to a predetermined potential, is detected, the address of the pixel is stored in the memory 104 and the output of the pixel at the address stored in the memory 104 is replaced with the output of a pixel having an address adjacent to the address of that pixel. Thus, even when the solid-state image pickup device 101 is applied to the electronic information apparatus 100, a black defect in a bright background which is conventionally difficult to be corrected can be handled as a white defect in a dark background which is more easily corrected, thereby making it possible to improve the quality of solid-state image pickup devices.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A solid-state image pickup device, comprising:
a plurality of pixels arranged two-dimensionally, wherein each pixel comprising
a reset section for resetting an electric charge accumulation voltage generated by photoelectric conversion, and
an amplification section for outputting a signal voltage corresponding to the electronic charge accumulation voltage;
a voltage switch section for switching a voltage to be supplied to the reset section between a reset voltage and a second reference voltage, the second reference voltage being lower than the reset voltage; and
a voltage fix section for fixing the electronic charge accumulation voltage to a predetermined value.

2. A solid-state image pickup device according to claim 1, wherein:
the reset section is a reset transistor comprising a first drive terminal, a second drive terminal, and a control terminal, wherein an electric charge accumulation voltage generated by photoelectric conversion is applied to the first drive terminal, a reset control voltage is applied to the control terminal, and a reset voltage is applied to the second drive terminal, so that the electric charge accumulation voltage is reset; and
the amplification section is an amplification transistor comprising a first drive terminal, a second drive terminal, and a control terminal, wherein the electronic charge accumulation voltage is applied to the control terminal and a first reference voltage is applied to the first drive terminal, so that a signal voltage corresponding to the electronic charge accumulation voltage is output from the second drive terminal,
the voltage switch section is a voltage switch section for switching a voltage supplied to the second terminal of the reset transistor between the reset voltage and the second reference voltage, the second reference voltage being lower than the reset voltage, and
the voltage fix section is a short circuit path which short circuits between the second terminal and the control terminal of the amplification transistor.

3. A solid-state image pickup device according to claim 2, wherein the plurality of pixels are arranged in a matrix having rows and columns, and
the voltage switch section switches a voltage supplied to the second drive terminal of the reset transistor between the reset voltage and a predetermined voltage or a ground voltage on a column-by-column basis, wherein the predetermined voltage is lower than the reset voltage, and the ground voltage is the second reference voltage.

4. A solid-state image pickup device according to claim 3, wherein the voltage switch section is an inverter.

5. A solid-state image pickup device, comprising
a plurality of pixels arranged two-dimensionally, wherein each pixel comprising:
a reset transistor comprising a first drive terminal, a second drive terminal, and a control terminal, wherein an electric charge accumulation voltage generated by photoelectric conversion is applied to the first drive terminal, a reset control voltage is applied to the control terminal, and a reset voltage is applied to the second drive terminal, so that the electric charge accumulation voltage is reset; and
an amplification transistor comprising a first drive terminal, a second drive terminal, and a control terminal, wherein the electronic charge accumulation voltage is applied to the control terminal and a first reference voltage is applied to the first drive terminal, so that a signal voltage corresponding to the electronic charge accumulation voltage is output from the second two drive terminals, and
a voltage switch section for switching a voltage supplied to the second terminal of the reset transistor between the reset voltage and a second reference voltage, the second reference voltage being lower than the reset voltage, so that a voltage greater than or equal to the voltage rating of a transistor can be applied the first drive terminal of the amplification transistor to cause a short circuit between the second drive terminal and the control terminal of the amplification transistor.

6. A solid-state image pickup device according to claim 5, wherein the plurality of pixels are arranged in a matrix having rows and columns, and
the voltage switch section switches a voltage supplied to the second drive terminal of the reset transistor between the reset voltage and a predetermined voltage or a ground voltage on a column-by-column basis, wherein the predetermined voltage is lower than the reset voltage, and the ground voltage is the second reference voltage.

7. A solid-state image pickup device according to claim 5, wherein the voltage switch section is an inverter.

8. A defective pixel conversion method, comprising the steps of:
applying light to the pixels of a solid-state image pickup device according to claim 2 on a wafer;
detecting a defective pixel with no response or an imperfect response to the light from the pixels; and
short circuiting the defective pixel between the first drive terminal and the control terminal of the amplification transistor thereof.

9. A defective pixel conversion method according to claim 8, wherein the second reference voltage is applied to the second drive terminal of the reset transistor of the defective pixel while the reset control voltage is applied to the control terminal of the reset transistor of the defective pixel, and a voltage greater than or equal to the voltage rating is applied to the first drive terminal of the amplification transistor.

10. A defective pixel conversion method, comprising the steps of:
applying light to the pixels of a solid-state image pickup device according to claim 5 on a wafer;
detecting a defective pixel with no response or an imperfect response to the light from the pixels; and
short circuiting the defective pixel between the first drive terminal and the control terminal of the amplification transistor thereof.

11. A defective pixel conversion method according to claim 10, wherein the second reference voltage is applied to the second drive terminal of the reset transistor of the defective pixel while the reset control voltage is applied to the control terminal of the reset transistor of the defective pixel, and a voltage greater than or equal to the voltage rating is applied to the first drive terminal of the amplification transistor.

12. A solid-state image pickup device, comprising a pixel, wherein the pixel is short circuited between the first drive terminal and the control terminal of the amplification transistor using a defective pixel conversion method according to claim 8.

13. A method for correcting a defect in a solid-state image pickup device, comprising the step of:
replacing an output of the converted cell in an solid-state image pickup device according to claim 12 with an output of a pixel having an address adjacent of an address of the converted cell by storing the address of the converted pixel in a memory.

14. A solid-state image pickup device, comprising a pixel, wherein the pixel is short circuited between the first drive terminal and the control terminal of the amplification transistor using a defective pixel conversion method according to claim 10.

15. A method for correcting a defect in a solid-state image pickup device, comprising the step of:
replacing an output of the converted cell in the solid-state image pickup device according to claim 14 with an output of a pixel having an address adjacent of an address of the converted cell by storing the address of the converted pixel in a memory.

16. An electronic information apparatus, comprising:
a solid-state image pickup device according to claim 1,
wherein the electronic information apparatus is used to subject image data picked up by the solid-state image pickup device to information processing.

17. An electronic information apparatus according to claim 16, wherein when a pixel in the solid-state image pickup device, whose electric charge accumulation region is constantly fixed to a predetermined potential, is detected, the address of the pixel is stored in a memory and an output of said pixel at the address stored in the memory is replaced with an output of a pixel having an address adjacent to the address of said pixel.

18. An electronic information apparatus, comprising:
a solid-state image pickup device according to claim 5,
wherein the electronic information apparatus is used to subjecting image data picked up by the solid-state image pickup device to information processing.

19. An electronic information apparatus according to claim 18, wherein when a pixel in the solid-state image pickup device, whose electric charge accumulation region is constantly fixed to a predetermined potential, is detected, the address of the pixel is stored in a memory and an output of said pixel at the address stored in the memory is replaced with an output of a pixel having an address adjacent to the address of said pixel.
